(19) United States
(12) Patent Application Publication
(10) Pub. No.: US 2009/0301667 A1
(43) Pub. Date: Dec. 10, 2009

(54) Textile blind slat

(76) Inventor: Jianming Yu, Ruian (CN)

Correspondence Address: ZHEN ZHENG LU, 1730 HUNTINGTON DRIVE #304, DUARTE, CA, 91010, US

(21) Appl. No.: 12/133,368

(22) Filed: Jun. 5, 2008

(51) Int. Cl. E06B 9/24

(52) U.S. Cl. 160/178.1 R; 160/236

(57) ABSTRACT

The present invention provides a method of making textile blind slat, including (a) weaving an elongated textile strip, wherein two longitudinal edge portions are double layered, forming an elongated inner space therein; (b) immerging the elongated textile strip into the hardening agent, wherein the elongated textile strip passes through the hardening agent at a predetermined speed; (c) squeezing the elongated textile strip for extruding the extra hardening agent and evenly distributing the hardening agent on the elongated textile strip, (d) drying the elongated textile strip after step (c) in a temperature between 100-180 Celsius degree; and (e) flattening the elongated textile strip after step (d), so as to serve as a transverse or vertical blind slat.

### BACKGROUND OF THE PRESENT INVENTION

1. Field of Invention

The present invention relates to a Venetian blind, and more particularly to a blind slat made of textile, wherein the textile is processed to be hardened, so as to be capable of serving as a blind slat of the Venetian blind.

2. Description of Related Arts

At present, there are many kinds of Venetian blind slat. They are usually made of hard materials, such as aluminum alloy, wood, bamboo and so on. Aluminum alloy is light in weight and water-proof, but the equipment for producing the aluminum alloy slat is quite expensive. In addition, the nonferrous metal is becoming less and less, so that the cost of the aluminum alloy slat is going to rise. The wood and bamboo slat is difficult to produce and has too many producing procedures. Furthermore, the wood and bamboo slat is not waterproof and easily gets transformed. The wood used as slat is basswood, which is identified as an endangered species, so that a good substitute has to be developed.

The Venetian blind slat made of plastic or resin is developed. However, when this kind of Venetian blind slat exposed to sunlight, it gets aged quickly, which will affects its outer appearance. Furthermore, the used Venetian blind after service is not environmentally friend.

The above mentioned hard materials have an important but unnoticed drawback. Because the blind slat is hard material, the width of the blind slat is predetermined during the production. When the window of the customer is not standard size, these predetermined blind slats can not be used. The cost of customer made Venetian blind is very high, and at the same time, the transportation cost of the blind slats is high too.

The blind slat made of hard material has another drawback of having a pair of slits at both edge portions of the blind slat for a rope passing through to connect all the blind slats. These slits will allow the sunlight passing therethrough, which will affect the shading effect of the Venetian blind.

However, soft materials such as textile are not suitable for making blind slat, because the blind slat must have a certain degree of hardness. Moreover, the textile does not have the advantages of waterproof, flame retardant, or ultraviolet screener.

### SUMMARY OF THE PRESENT INVENTION

An object of the present invention is to reinforce the hardness of the textile, so as to make the textile suitable for applying to the Venetian blind slat.

Another object of the present invention is to provide a textile blind slat, which has advantages of water proof, mildewproof, flame retardant, or ultraviolet screener, which conform the international standards.

Another object of the present invention is to provide a textile blind slat, whose width can be determined by the customer.

Another object of the present invention is to provide a textile blind slat, which is convenient for transportation, manufacture and use.

Another object of the present invention is to provide a method of making a textile blind slat, which can harden the textile, so as to make it suitable for serving as a blind slat.

Another object of the present invention is to provide a method of making textile blind slat, wherein the bind slat has advantages of water proof, flame retardant, or ultraviolet screener, which conforms the international standards.

Another object of the present invention is to provide a method of making Venetian blind, which do not need open a pair of slits on both edge portions of the blind slat.

Accordingly, in order to accomplish the above object, the present invention provides a textile blind slat including:

an elongated textile strip, wherein two longitudinal edge portions are double layered, forming an elongated inner chamber therein;

a hardening agent penetrated into the elongated textile strip, so as to harden the elongated textile strip; and

two poles having a certain flexibility degree, for being inserted into the elongated inner chamber of the two longitudinal edge portions respectively.

The present invention also provides a method of making textile blind slat, including:

(a) weaving an elongated textile strip, wherein two longitudinal edge portions are double layered, forming an elongated inner space therein;

(b) immerging the elongated textile strip into a hardening agent, wherein the elongated textile strip passes through the hardening agent at a predetermined speed;

(c) squeezing the elongated textile strip for extruding the extra hardening agent and evenly distributing the hardening agent on the elongated textile strip.

(d) drying the elongated textile strip after step (c) in a temperature between 100-180 Celsius degree; and

(e) flattening the elongated textile strip after step (d), so as to serve as a transverse or vertical blind slat.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a blind slat according to a preferred embodiment of the present invention, illustrating a practical application of the blind slat.

FIG. 2 is a schematic view of the blind slat according to the above preferred embodiment of the present invention.

FIG. 3 is a schematic view of a method of making a blind slat according to the above preferred embodiment of the present invention.

### DETAILED DESCRIPTION OF THE PREFERRED EMBODIMENT

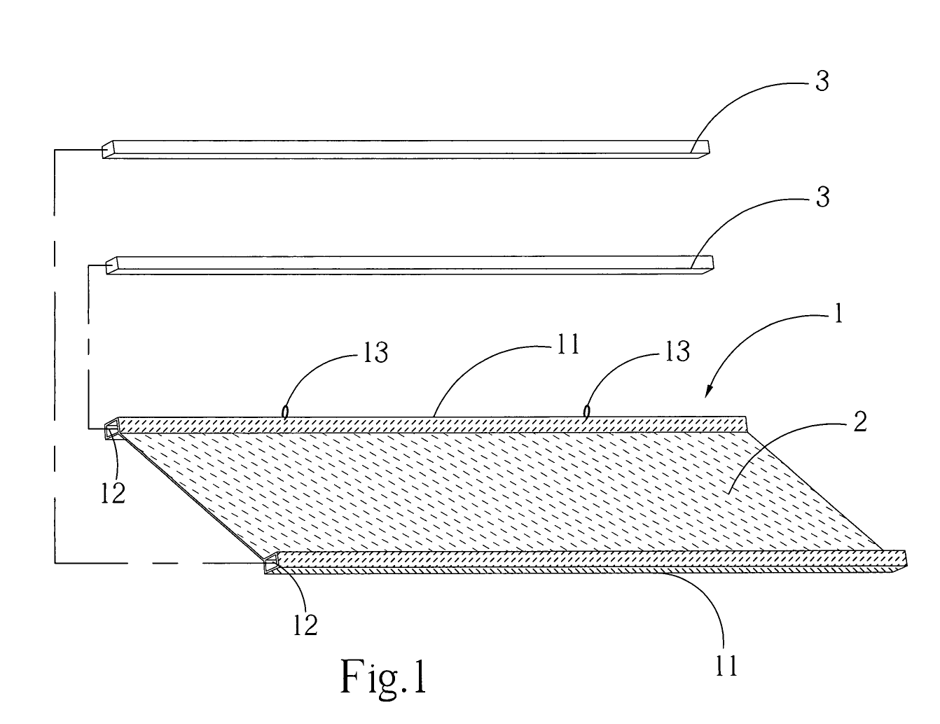

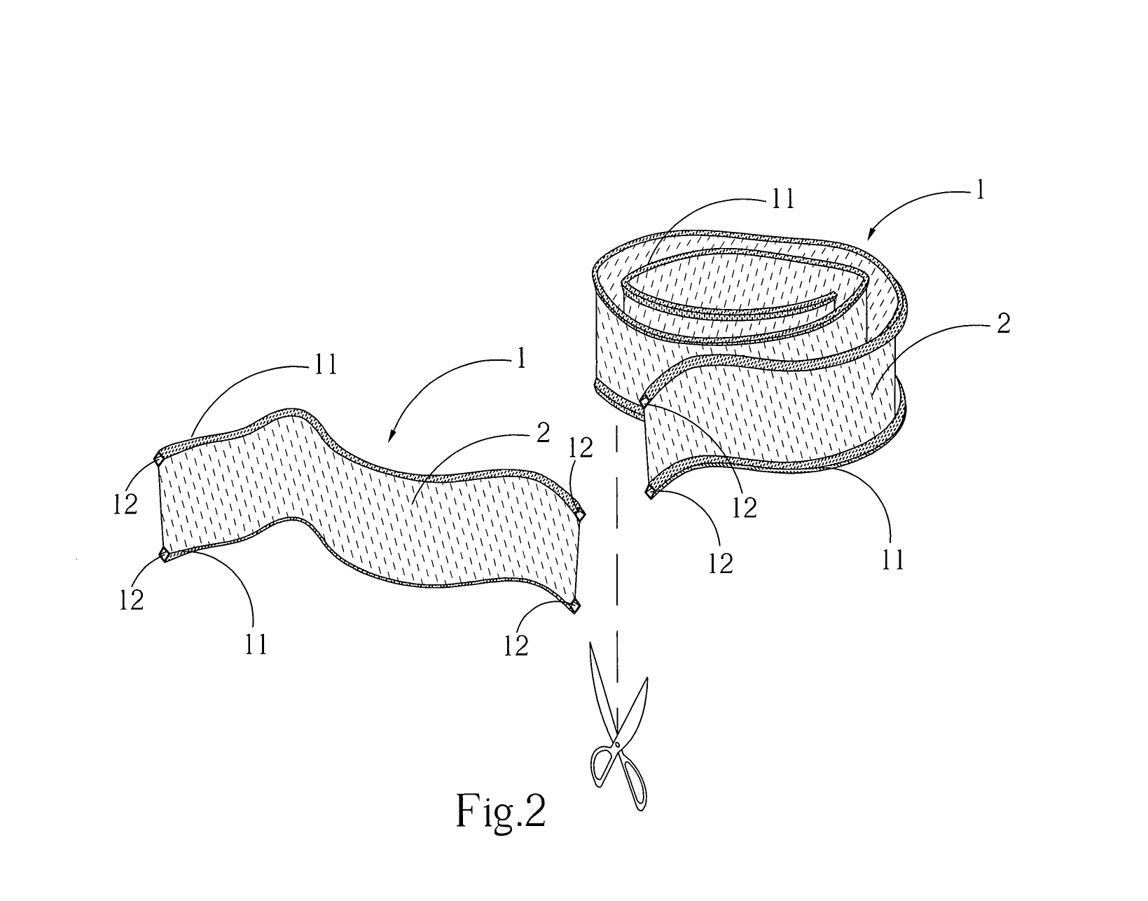

Referring to FIG. 1 and FIG. 2 of the drawings, a textile blind slat according to a preferred embodiment of the present invention is illustrated, in which the textile blind slat comprises an elongated textile strip 1, a hardening agent 2 and two poles 3.

Two longitudinal edges 11 of the elongated textile strip 1 are woven to be double layered, so as to form an elongated inner chamber 12 therein. The textile is polyester, including polyester filament yarn, polyester drawn textured yarn, polyester high elastic filament, polyester network filament, and so on. The polyester has high intensity, resists to ageing, and high temperature up to 180 Celsius degree. In addition, the polyester is waterproof and mildewproof. Therefore, the polyester is an ideal material to produce Venetian blind slat.

The transverse length of the blind slat is 2-15 cm, the knitting density is 3-40 lines per centimeter, and the thickness of the knitting is 0.1-2 mm. The longitudinal edge 11 is woven to be double layered, forming an elongated inner chamber 12.

The hardening agent 2 is fully penetrated into the elongated textile strip 1, and is dried under a high temperature of 100-180 Celsius degree, so as to harden the elongated textile strip 1. The hardening agent is resin, polyacylate latex, or polyacrylic acid water based adhesive. The polyacylate latex connects the textile fibers forming a hardening agent layer on the textile fibers, so as to harden the elongated textile strip 1. It is worth mentioning that the hardening agent does not contain Formaldehyde, and will not release Formaldehyde.

The two poles 3 are hard and have certain flexibility for being inserted into the elongated inner chamber 12 of the two longitudinal edge portions respectively, so as to further reinforce the hardness of the elongated textile strip. The pole has a diameter of 1-10 mm. The pole is made of glassfiber, metal, or plastic.

The elongated textile strip 1 further comprises a plurality of rings 13 spacedly provided at a longitudinal side of the elongated textile strip 1, thus the textile blind slats are connected via a rope passing through the rings. The rings 13 is woven to the longitudinal side of the elongated textile strip 1, or stitched up to the longitudinal side of the elongated textile strip 1. The ring 13 has a diameter of 1-30 mm, and the density of the rings 13 is 1-20 per meter.

The textile can be dyed to any color, so that the textile blind slat can be of various colors. Likewise, the textile blind slat has predetermined patterns thereon, which will not be achieved by traditional blind slat.

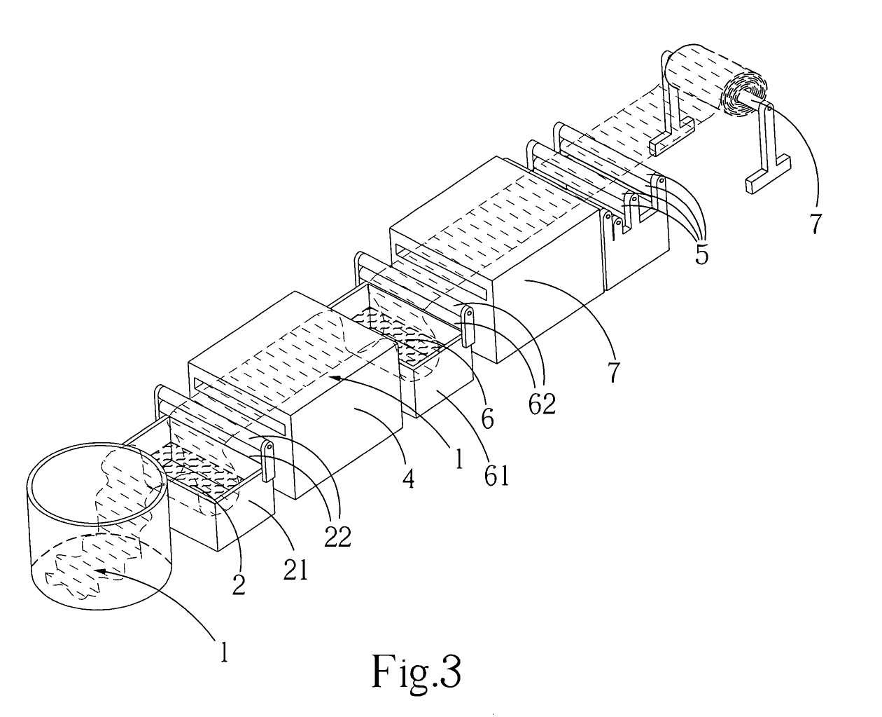

Referring to FIG. 3 of the drawings, the present invention also provides a method of making the textile blind slat, including:

(a) weaving an elongated textile strip 1, wherein two longitudinal edge portions 11 are double layered, forming an elongated inner chamber 12 therein;

(b) immerging the elongated textile strip 1 into a hardening agent 2, wherein the elongated textile strip 1 passes through the hardening agent 2 at a predetermined speed;

(c) squeezing the elongated textile strip 1 for extruding the extra hardening agent 2 and evenly distributing the hardening agent 2 on the elongated textile strip 1. (d) drying the elongated textile strip 1 after step (c) in a temperature between 100-180 Celsius degree; and

(e) flattening the elongated textile strip 1 after step (d), so as to serve as a transverse or vertical blind slat.

As shown in FIG. 2, the elongated textile strip 1 can be woven to any length, and is rolled to be stored, so as to save space. When making the Venetian blind, the blind slat can be cut to any length according to the requirement, so as to make a Venetian blind with an appropriate width.

Two longitudinal edges 11 of the elongated textile strip 1 are woven to be double layered, so as to form an elongated inner chamber 12 therein. The textile is polyester, including polyester filament yarn, polyester drawn textured yarn, polyester high elastic filament, polyester network filament, and so on. The polyester has high intensity, resists to ageing, and high temperature up to 180 Celsius degree. In addition, the polyester is waterproof and mildewproof. Therefore, the polyester is an ideal material to produce Venetian blind slat.

The transverse length of the blind slat is 2-15 cm, the knitting density is 3-40 lines per centimeter, and the thickness of the knitting is 0.1-2 mm. The longitudinal edge is woven to be double layered, forming an elongated inner chamber 12.

The elongated textile strip 1 further comprises a plurality of rings 13 spacedly provided at a longitudinal side of the elongated textile strip 1, thus the textile blind slats are connected via a rope passing through the rings. The rings 13 is woven to the longitudinal side of the elongated textile strip 1, or stitched up to the longitudinal side of the elongated textile strip 1. The ring 13 has a diameter of 1-30 mm, and the density of the rings 13 is 1-20 per meter.

The textile can be dyed to any color, so that the textile blind slat can be of various colors. Likewise, the textile blind slat has predetermined patterns thereon, which will not be achieved by traditional blind slat.

The above steps (a) (b) (c) (d) (e) may be proceeding at the same time. Also the steps (b) (c) (d) (e) may be proceeding at the same time, after step (a) is done. In this preferred embodiment, the steps (b) (c) (d) (e) are proceeding at a speed of 2-50 m/s at the same time.

In step (b), the hardening agent 2 is in a hardening agent container 21, and the elongated textile strip 1 passes through the container 21 at a predetermined speed, so as to ensure the hardening agent 2 is fully penetrated into the elongated textile strip 1. The hardening agent 2 is resin, polyacylate latex, or polyacrylic acid water based adhesive. It is worth mentioning that the hardening agent 2 does not contain Formaldehyde, and will not release Formaldehyde.

In step (c), the elongated textile strip 1 is squeezed by a pair of squeezing rollers 22. When the elongated textile strip 1 passes through a space between the pair of squeezing rollers 22, the extra hardening agent 2 is extruded.

In step (d), the elongated textile strip is dried in a drying oven 4 having a temperature 100-180 Celsius degree. The polyacylate latex connects the textile fibers forming a hardening agent layer on the textile fibers, so as to harden the elongated textile strip 1.

In step (e), the elongated textile strip after step (c) is flattened by passing through a pair of flattening rollers 5. When the elongated textile strip 1 passes through a space between the pair of flattening rollers 5, the elongated textile strip 1 is flattened.

Before step (e), the method of making textile blind slat further includes steps of:

(d1) immerging the elongated textile strip 1 into a additive agent 6, wherein the elongated textile strip 1 passes through the additive agent 6 at a predetermined speed;

(d2) squeezing the elongated textile strip 1 for extruding the extra additive agent 6 and evenly distributing the additive agent 6 on the elongated textile strip; and

(d3) drying the elongated textile strip 1 after step (d2) in a temperature between 100-180 Celsius degree.

The additive agent 6 includes Fluorinated Compounds, which can prevent liquid from passing through the textile, so that the textile blind slat is waterproof. The Fluorinated Compounds also lower the surface tension, so as to prevent oil. The Fluorinated Compounds do not contain PFOA, which is forbidden by EU.

The additive agent 6 further includes a flame retardant agent, such as bromine, antimony, phosphorus compounds and so on. The flame retardant agent will melt under a high temperature and cover the textile to block the air flow, which will prevent the combustible gas produced in the textile diffusing outwards, or decompose non-combustible gas to dilute the combustible gas, or lower the melting temperature of the textile, so that the textile drops while melting.

The additive agent 6 further includes an ultraviolet absorber agent, which can absorb the ultraviolet, or reflect the ultraviolet outwards. The additive agent 6 further includes sun screen agent, such as titanium oxide, black carbon, or paint.

In step (d1), the additive agent 6 is in an additive agent container 61, and the elongated textile strip 1 passes through the container 61 at a predetermined speed, so as to ensure the additive agent 6 is fully penetrated into the elongated textile strip 1. In step (d2), the elongated textile strip 1 is squeezed by a second pair of squeezing rollers 62. When the elongated textile strip 1 passes through a space between the second pair of squeezing rollers 62, the extra additive agent 6 is extruded. In step (d3), the elongated textile strip 1 is dried in a second drying oven 7 having a temperature 100-180 Celsius degree.

After step (e), the method of making textile blind slat further includes a step of: (f) winding the elongated textile strip forming a roll of elongated textile strip, so as to be easily stored. As shown in FIG. 3, the elongated textile strip is rolled up by a winding machine 8.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A textile blind slat, comprising:
an elongated textile strip, wherein two longitudinal edge portions are double layered, each forming an elongated inner chamber therein;
a hardening agent penetrated into said elongated textile strip, so as to harden said elongated textile strip; and
two poles having a certain flexibility degree, for being inserted into said elongated inner chamber of said two longitudinal edge portions respectively.

2. The textile blind slat, as recited in claim 1, wherein said elongated textile strip is made of polyester selected from a group consisting of polyester filament yarn, polyester drawn textured yarn, polyester high elastic filament, and polyester network filament.

3. The textile blind slat, as recited in claim 2, wherein said hardening agent is resin.

4. The textile blind slat, as recited in claim 2, wherein said hardening agent is selected from a group consisting of polyacylate latex and polyacrylic acid water based adhesive.

5. The textile blind slat, as recited in claim 1, wherein said elongated textile strip further comprises a plurality of rings spacedly provided at a longitudinal side of said elongated textile strip.

6. The textile blind slat, as recited in claim 4, wherein said elongated textile strip further comprises a plurality of rings spacedly provided at a longitudinal side of said elongated textile strip.

7. The textile blind slat, as recited in claim 1, wherein said elongated textile strip has predetermined pattern designed thereon.

8. The textile blind slat, as recited in claim 4, wherein said elongated textile strip has predetermined pattern designed thereon.

9. A method of making textile blind slat, comprising:
(a) weaving an elongated textile strip, wherein two longitudinal edge portions are double layered, forming an elongated inner chamber therein;
(b) immerging said elongated textile strip into a hardening agent, wherein said elongated textile strip passes through said hardening agent at a predetermined speed;
(c) squeezing said elongated textile strip for extruding said extra hardening agent and evenly distributing said hardening agent on said elongated textile strip;
(d) drying said elongated textile strip after step (c) in a temperature between 100-180 Celsius degree; and
(e) flattening said elongated textile strip after step (d), so as to serve as a blind slat.

10. The method of making textile blind slat, as recited in claim 9, wherein said elongated textile strip is made of polyester selected from a group consisting of polyester filament yarn, polyester drawn textured yarn, polyester high elastic filament, and polyester network filament.

11. The method of making textile blind slat, as recited in claim 10, wherein said elongated textile strip further comprises a plurality of rings spacedly provided at a longitudinal side of said elongated textile strip.

12. The method of making textile blind slat, as recited in claim 11, wherein said elongated textile strip is woven of a predetermined length, and rolled up to be stored.

13. The method of making textile blind slat, as recited in claim 12, wherein said elongated textile strip has predetermined pattern designed thereon.

14. The method of making textile blind slat, as recited in claim 9, wherein steps of (b) (c) (d) (e) are proceeding with a speed of 2-50 m/s at same time.

15. The method of making textile blind slat, as recited in claim 14, wherein in step (b), said hardening agent is in a hardening agent container, and said elongated textile strip passes through said hardening agent container at a predetermined speed, so as to ensure said hardening agent is fully penetrated into said elongated textile strip.

16. The method of making textile blind slat, as recited in claim 15, wherein said hardening agent is resin.

17. The method of making textile blind slat, as recited in claim 15, wherein said hardening agent is selected from a group consisting of polyacylate latex and polyacrylic acid water based adhesive.

18. The method of making textile blind slat, as recited in claim 14, before step (e), further comprising steps of:
(d1) immerging an elongated textile strip into a additive agent, wherein said elongated textile strip passes through said additive agent at a predetermined speed;
(d2) squeezing said elongated textile strip for extruding said extra additive agent and evenly distributing said additive agent on said elongated textile strip; and
(d3) drying said elongated textile strip after step (d2) in a temperature of 100-180 Celsius degree.

19. The method of making textile blind slat, as recited in claim 18, wherein said additive agent includes Fluorinated Compounds.

20. The method of making textile blind slat, as recited in claim 18, wherein said additive agent includes an ultraviolet absorber agent, a sun screen agent and a flame retardant agent selected from a group consisting of bromine, antimony, and phosphorus compounds.
